(19) United States
(12) Patent Application Publication
(10) Pub. No.: US 2006/0065770 A1
(43) Pub. Date: Mar. 30, 2006

(54) Material processing apparatus and methods

(75) Inventors: J. Mark Hausman, Medina, OH (US); Richard B. Turner, Lake Worth, FL (US)

Correspondence Address: HAHN LOESER & PARKS, LLP, One GOJO Plaza, Suite 300, AKRON, OH, 44311-1076, US

(73) Assignee: ARMEX, INC.

(21) Appl. No.: 11/274,018

(22) Filed: Nov. 15, 2005

Related U.S. Application Data
(63) Continuation-in-part of application No. 11/011,559, filed on Dec. 14, 2004.
(60) Provisional application No. 60/533,490, filed on Dec. 31, 2003.

(51) Int. Cl. B02C 18/16

(52) U.S. Cl. 241/285.1

(57) ABSTRACT

The present invention relates to a material processing apparatus. The apparatus includes a frame including a pair of laterally opposed parallel sides and a base, and at least a first pair of substantially cylindrical material processing rolling assemblies, wherein each pair of rolling assemblies are driven by a hydraulic drive motor assembly, such that using the hydraulic drive motors, the rolling assemblies can be driven at a variable friction ratio.

This application is a Continuation-In-Part patent application that claims the priority to U.S. Utility patent application Ser. No. 11/011,559 filed on Dec. 14, 2004, which claims priority to U.S. Provisional Patent Application Ser. No. 60/533,490, filed Dec. 31, 2003, herein incorporated by reference.

### TECHNICAL FIELD

This invention relates to systems and methods for the size reduction of materials. More particularly, this invention relates to systems and methods for the size reduction of elastomeric materials by tearing and grinding the materials between rotating milling rollers.

### BACKGROUND OF THE INVENTION

Scrap tires are generated at a rate of 270 million per year in the United States. They are non-biodegradable having been originally designed to last, when placed on a motorized vehicle, for tens of thousands of road miles. They are comprised of rubber, approximately 70% by weight, steel, approximately 20% by weight, and reinforcing textile fibers.

The disposal or reuse of previously used rubber products, such as rubber tires, presents many problems. Ecologically, rubber tires degrade very slowly and if disposed of improperly, may lead to hazardous environmental conditions in terms of both potential ground water problems and other ecological effects. The standard practice to remove these scrap tires from the solid waste stream has been to first run the tire through a tire shredder. Once shredded, the tire shreds can be returned to the solid waste stream, burned as tire derived fuel (TDF) or used as a feedstock for further processing into small, mesh size crumb rubber.

Recently, recycling of pre-used rubber or similar polymer products has increased in popularity in order to avoid potential negative environmental impact as well as to provide potentially commercially reusable rubber products.

Several methods for recycling used rubber products exist. Often, rubber products such as rubber tires are rendered into fine particulate rubber, which then may be reused in other rubber products or other uses. However, one of the difficulties with recycling rubber products such as tires is that such products are extremely durable and consequently difficult to reduce to a re-usable form. In order for any recycling effort to be cost effective, a method must be developed to reduce the extremely durable rubber products to a form of rubber that may be useable in further processes. Recycled rubber particles become more commercially valuable with decreasing particle size. The commercial value increases because rubber particles of smaller sizes may be more easily incorporated into a wider variety of new or recycled products or other applications.

Rubber recycling reclamation or granulating machines may be classified into two types. A first type produces fairly large rubber particles and operates at room temperature, relating to a shredder often using rotating knives to produce the particles. Although the process is fairly inexpensive, the large rubber particles produced, while usable for applications such as ground cover, are not generally usable for more commercially desirable applications such as new rubber products. A second type of rubber reclamation is cryogenic grinding methods where the machinery operates at extremely low temperatures using liquid nitrogen. Because the process requires continual replenishment of liquid nitrogen for maintaining operation at low temperatures, the process is fairly expensive and cumbersome.

Current two roll mill systems are used for a variety of purposes, including blending and mixing of elastomeric materials. Certain two roll mill designs have been used for reducing the particle size of materials. Two roll mills as previously designed have various drawbacks, such as the rolls are difficult to remove for maintenance. This results in relatively long periods of down time, and significantly decreases the productivity of the system in processing material. Additionally, upon wearing of a roll, which are generally constructed of cast iron, the roll must be remachined, allowing only limited refurbishing until replacement is required. The cast iron roll is also very heavy and cumbersome to handle, and adds significantly to the overall weight of the mill. Due to the inability to easily replace one or both rolls in the mill, these systems are generally limited in the processing characteristics thereof, based upon the roll configuration and other parameters.

Another disadvantage with presently-known two roll mill systems is that the rolls are driven by electromechanical drives which must be designed to accommodate high shock loads, as encountered in rubber processing, for example. The high shock loads created by introduction of material between the rolls, can ultimately lead to stalling of the mill. Furthermore, unsealed bronze sleeve bearings typically used in two roll mill systems need to be water-cooled, and generally leak significant amounts of grease or other lubricant used therewith, causing possible contamination of the materials being processed and other problems. These bearings also can be contaminated by the rubber or other particles entering the bearing. Current two roll mill systems also operate at a fixed friction ratio, and generally have no speed differential between the two rolls or, if any, only a ratio of up to 3:1 is obtained by gear reduction in known systems. Additionally, known roll mills are generally constructed with a cast iron frame having sufficient structural integrity to withstand the significant forces imposed on the rolls, making the system extremely heavy and requiring significant floor space in a plant environment. Thus, moving or otherwise handling such systems is difficult, and suitable support must be provided.

Accordingly, there is a need for a materials processing system and methods that avoid the deficiencies of the prior art machines and methods, to provide a cost-effective and efficient processing system. There is thus a need for an improved two roll mill system which overcomes the problems of previous mill designs for processing of materials. There is also a need for materials processing machinery and methods which allow effective ambient processing of materials, particularly elastomeric materials.

### SUMMARY OF THE INVENTION

Based upon the foregoing and other problems and deficiencies of prior materials processing systems and methods, the present invention is directed to a materials processing system and methods, which overcome these problems and deficiencies of such prior system and methods. In one aspect of an embodiment of the subject invention, a material processing apparatus comprises a modular frame including a pair of laterally opposed sides and a base. First and second material processing rolling assemblies are operatively and rotatably connected with respect to the frame. A hydraulic drive motor directly connected to the first and second material processing rolling assemblies, provides independent control of each of the first and second material processing rolling assemblies, to allow the rolls to be driven at different speeds, and at differential speeds to provide a significantly increased speed or friction ratio between the rolls.

Another aspect of an embodiment of the subject invention includes at least a first hydraulically driven radial piston motor or hydraulically driven variable speed radial piston motor.

Yet another aspect of an embodiment of the subject invention includes a first hydraulic drive motor directly connected to the first material processing rolling assembly, and, a second hydraulic drive motor directly connected to the second material processing rolling assembly.

Another aspect of an embodiment of the subject invention includes a hydraulic fluid output of the first hydraulic drive motor that is operatively connected to an input of the second hydraulic drive motor creating a regenerative hydraulic circuit for driving the first and second hydraulic drive motors at different speeds.

Still another aspect of an embodiment of the subject invention includes a hydrostatic power supply operatively connected to the first and second hydraulic motors, such as a closed loop hydrostatic transmission.

Another aspect of an embodiment of the subject invention includes a frame including a pair of laterally opposed parallel sides and a base, first and second material processing rolling assemblies operatively rotatably connected with respect to the frame, at least a first drive motor operatively connected to one of the first and second material processing rolling assemblies, wherein the first and second material processing rolling assemblies include respective outer material processing surfaces having a plurality of corrugations fashioned at an angle A with respect to a longitudinal axis of the first and second material processing rolling assemblies, and, wherein the angle A is in the range of 6 degrees to 14 degrees, or more particularly in a range between 7-12 degrees, with it being found that an angle of approximately 10 degrees performs in the desired fashion for many applications.

Yet another aspect of an embodiment of the subject invention includes a plurality of corrugations fashioned at an angle A with respect to the longitudinal axis that form a right-hand helix around the outer material processing surfaces of the first and second material processing rolling assemblies respectively.

Even yet another aspect of an embodiment of the subject invention includes a plurality of corrugations fashioned at an angle A that are substantially parallel forming a land width, where the land width is in the range of 0.250 inches to 0.60 inches, and more particularly in the range of 0.300 to 0.500 inches. Further, the depth of the corrugations or teeth may vary for altering processing characteristics, where the depth is in the range of 0.250 to 0.050 inches, and more particularly in the range of 0.125 to 0.080 inches. In methods according to the invention, materials are processed in a plurality of stages of the material processing rolling assemblies, with the depth of the corrugations or processing teeth successively becoming reduced, while the land width is successively increased. The design of the teeth may also be varied to affect alternative processing characteristics, with the present invention describing U-shaped, V-shaped and saw-tooth type of configurations.

Still another aspect of an embodiment of the subject invention includes a frame including a pair of laterally opposed parallel sides and a base, first and second material processing rolling assemblies operatively rotatably connected with respect to the frame, at least a first drive motor operatively connected to at least one of the first and second material processing rolling assemblies, and, wherein each the first and second material processing rolling assemblies are composed of a generally cylindrical middle roll body, an outer corrugated sleeve received over the middle roll body, and, first and second end plates operatively connected to hold the middle roll body and sleeve together for rotation during the processing of associated material.

Still yet another aspect of an embodiment of the subject invention includes a first end plate that is a drive plate having a shaft portion configured to directly connect to the at least a first drive motor.

Yet another aspect of an embodiment of the subject invention includes a second end plate that is a non-driven plate having a shaft portion operatively rotatably connected with respect to the frame.

A further aspect of an embodiment of the subject invention includes at least a first spherical bearing operatively connected to the shaft portion of at least one of the first and second end plates.

Still another aspect of an embodiment of the subject invention includes a middle roll body that is hollow for use in dissipating heat generated during material processing.

Even another aspect of an embodiment of the subject invention includes a middle roll body that is adapted to receive a cooling fluid for use in dissipating heat generated during material processing.

Yet another aspect of an embodiment of the subject invention includes a frame including a pair of laterally opposed parallel sides and a base, the sides of the frame being constructed of steel plates, first and second material processing rolling assemblies operatively rotatably connected with respect to the frame, at least a first drive motor operatively connected to one of the first and second material processing rolling assemblies, and, at least a first spherical bearing operatively connected between the at least one of the first and second material processing rolling assemblies and the frame.

Still yet another aspect of an embodiment of the subject invention includes a second or further frame(s) including a pair of laterally opposing parallel sides, third and fourth material processing rolling assemblies operatively rotatably connected with respect to the second frame, at least a second drive operatively connected to at least one of the third and fourth material processing rolling assemblies, and, wherein the second or further frame(s) is fixedly connected to the first frame in a stacked relationship such that associated material processed by the third and fourth material processing rolling assemblies are automatically fed into the first and second material processing rolling assemblies for further processing.

Yet another aspect of an embodiment of the subject invention includes a cross section of the corrugations of the first and second material processing rolling assemblies are different, such as having a V-tooth configuration on one roll and a U-tooth configuration, or a saw-tooth configuration on the other roll. With multiple stage of roll pairs, further variations between roll pairs may be provided, such as, wherein the cross section of the corrugations of the first and second material processing rolling assemblies has a V-tooth and saw-tooth configuration, and, wherein first and third and fourth material processing rolling assemblies have corrugations, wherein the cross section of each of the corrugations of the third and fourth material processing rolling assemblies has a saw-tooth configuration.

Still another aspect of an embodiment of the subject invention includes first and second material processing rolling assemblies that have a V-tooth configuration, and, wherein a further pair of rolls is provided with the cross section of the corrugations of the third material processing rolling assemblies has a V-tooth configuration, and, wherein the cross section of the corrugations of the fourth material processing rolling assemblies has a saw-tooth configuration.

An even further aspect of an embodiment of the subject invention includes a generally cylindrical roll having an outer surface, the outer surface having a plurality corrugations spaced apart in a parallel relationship by a land width, and, wherein the land width is in the range between 0.25 inches and 0.60 inches, and, wherein the corrugations form an angle A with a longitudinal axis of the roll in a right hand helical configuration, wherein the angle A is in the range between 6 degrees and 14 degrees.

Still yet another aspect of an embodiment of the subject invention includes a first drive plate having a shaft, wherein the shaft has splined end for directly connecting with an associated drive motor, and, a second end plate having a shaft, wherein the shaft has a journalled end for operatively connecting to an associated bearing.

The present invention relates to a material processing apparatus and method. The apparatus includes a frame having a pair of laterally opposed parallel sides and a base, and at least a first pair of substantially cylindrical material processing rolling assemblies, wherein each pair of rolling assemblies are counter-rotating assemblies, forming a nip therebetween through which material is processed. Each of the rolls is driven with a hydraulic drive motor assembly, such that the apparatus is capable of obtaining an increased variable friction ratio, which is selectively varied, and which is greater than 3:1. More preferably, the variable friction ratio is greater than 10:1, with a range of 10 to 20:1 being found to be advantageous for processing of rubber and other materials. Further, a variable friction ratio between the rolls of up to 60:1 can be achieved. Corresponding to this, the rolls can be selectively driven at varied speeds or rotations per minute (rpm), to achieve the desired friction ratio. For example, one roll may be rotated at between 0-10 rpm's while the other roll may be rotated at between 0-60 rpm's. The hydraulic drives for the rolls may also provide a desired torque, which can be selectively varied up to 60:1, between the rolls.

In accordance with another aspect of the present invention, a method of reducing the particle size of a material is provided. The method includes feeding a material into a material processing apparatus, the material processing apparatus comprising a frame supporting at least a first pair of rolls rotatably driven in counter-rotating relationship at a variable differential speed relative to one another, processing the material through the at least first pair of rolls, and conveying the material away from the material processing apparatus.

These and other advantages and novel features of the present invention, as well as details of an illustrated embodiment thereof, will be more fully understood from the following description and drawings.

### BRIEF DESCRIPTION OF THE DRAWINGS

FIG. 1 is a side elevational view in partial section of a first embodiment of the material processing apparatus of the present invention;

FIG. 2 is another side elevational view of FIG. 1 in partial section of the material processing apparatus of the present invention;

FIG. 3 is a cross-sectional view of the bearing shaft assembly of the present invention;

FIG. 4 is a side view of the end cap of the material roller processing assembly of the present invention;

FIG. 5 is a cross-sectional view of the material roller processing assembly of the present invention;

FIG. 6 is a side elevational view in partial section of a second embodiment of the present invention;

FIG. 7 is another side elevational view of FIG. 6 in partial section of a second embodiment of the material processing apparatus of the present invention;

FIG. 8 is partial cutaway view of the roller assembly showing the sleeve and middle roll body, along with the angle of the corrugations fashioned in the sleeve.

FIG. 9 is a side view of the drive plate of the roller assembly showing the shaft and splined end;

FIG. 10 is a side view of the non-driven end plate of the roller assembly showing the shaft and journalled end;

FIG. 11 is a cross sectional close up view of the corrugations of the roller assembly and/or sleeve depicting the saw tooth configuration; and,

FIG. 12 is a cross sectional close up view of the corrugations of the roller assembly and/or sleeve depicting the V-tooth configuration.

FIG. 13 is a cross sectional close up view of the corrugations of the roller assembly and/or sleeve depicting the U-tooth configuration.

### DETAILED DESCRIPTION OF THE INVENTION

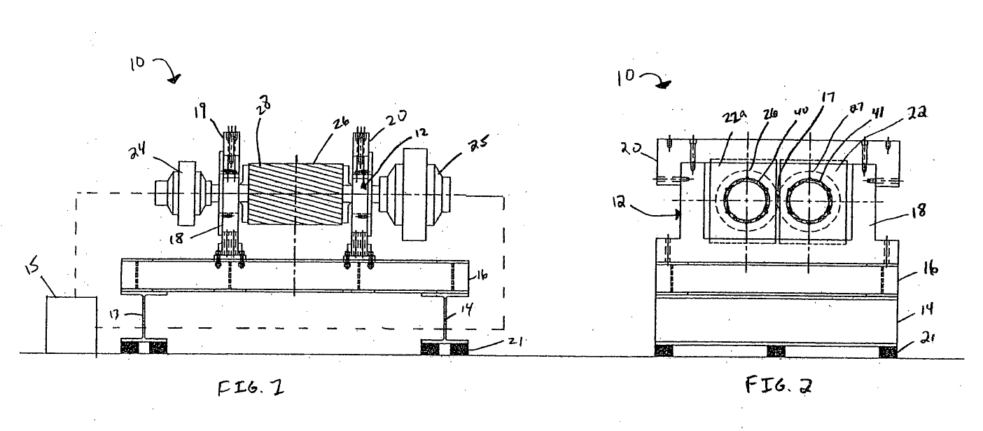

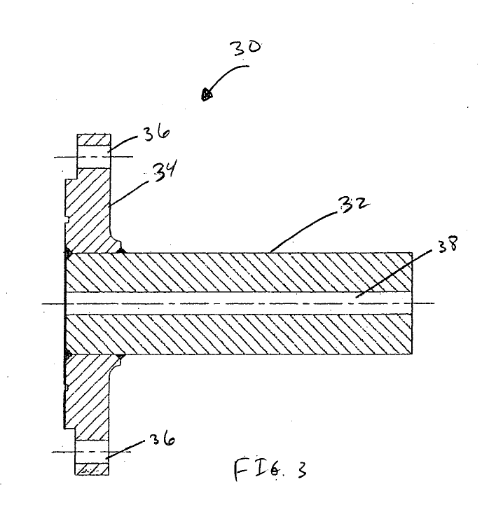

As shown in FIGS. 1 and 2, a first embodiment of the present invention is shown. The material processing apparatus of the present invention, generally designated 10, comprises a support frame 12, which may be constructed modularly. Prior mill designs have utilized large cast iron frames to support roll members, resulting in a unitary heavy from which is also susceptible to cracking. In the present invention, the frame is modular, having separate members which are easily assembled, such as a pair of support legs 13 and 14 on which a base 16 is supported. Side support members 15 may include sidewall portions 18 and cap portions 20. The support frame 12, sidewall portions 18, support legs 13 and 14, and base 16 may be constructed from steel, as steel provides enhanced structural integrity while being lightweight, and is also less susceptible to cracking than cast iron. In particular, the steel may be cold rolled steel, although any type of processed steel may be utilized as chosen with sound engineering judgment. Anti-vibrational mounts 21 may be added to the bottom portion of support legs 14 for noise reduction purposes and to stabilize the apparatus in position. Sidewall portions 18 and cap portions 20 support end bearing housings 22a and 22, which may comprise sealed, bearings for support of the drive shaft at each material processing rolling assembly 26 and 27.

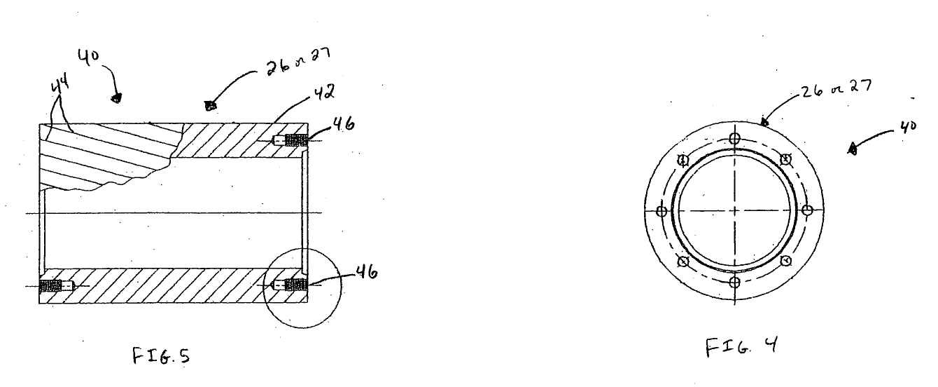

A pair of drive motor assemblies 24 and 25 are provided for rotatably driving the rolls 26 and 27 in a desired manner. Each drive motor assembly 24 and 25 includes an output shaft which is in turn drivingly coupled to a roll mount assembly 30, as seen in FIG. 3. The drive motors 24 and 25 are preferably hydraulic drive motors that can drive each roll 26 and 27 at a variable speed. In one embodiment, the hydraulic drive motors may be variable speed hydraulic drive motors. As seen in FIGS. 1 and 2, the rolls 26 and 27 are positioned adjacent one another to form a processing zone or nip 17 between the rolls 26 and 27. As will be described in more detail, the drive motors 24 and 25 may drive rolls 26, and 27 at differential speeds, such that within zone 17, compression and shearing of material occurs. The rolls 26 and 27 may also be provided with a processing surface, which may have corrugations 28 formed therein. In combination, these provide the forces on material to tear and shred the material processed therethrough.

To ensure that the processing zone between rolls 26 and 27 operates in the intended manner, the position and stability of the rolls is important. Prior mill designs utilized bronze sleeve bearings to mount the rolls, which were susceptible to wear and variability on the distance between rolls. The material processing apparatus 10 of the present invention may utilize spherical bearings to support rolls 26 and 27. These bearings are capable of withstanding higher pressures and temperatures than the prior bronze sleeve bearings. The spherical bearings are sealed, and there is no requirement for water cooling of these bearings. Further, by being sealed, grease spills or contamination are no longer a problem. Further, the possibility of contamination from small particles of material being processed is no longer a concern. It is contemplated in an alternate embodiment that the bearings may be tapered roller bearings.

As mentioned, the apparatus may utilize hydraulic drives 26 and 27 to provide driving power to rolls 24 and 25. Prior milling systems utilized electric motors, which due to the high torque loads experienced by the rolls, would have difficulty in driving the rolls at a uniform speed. Such loads could also cause shut down of the motors, interrupting processing. Also, to achieve any differential speed between the rolls, gear reduction was necessary. In the present drive system, using hydraulic motors, the need for gear reducers is eliminated. The hydraulic motors provide more uniform drive of rolls 24 and 25, and are also capable of handling high shock loads. The hydraulic drives provide the added benefit of increasing the torque value for each roll while virtually eliminating roll stoppage or stalling during the particle size reduction process. In one embodiment, the hydraulic motors are Models CA50, CA70 or CA100 motors as manufactured by Hagglunds, but other suitable motors are contemplated.

A hydrostatic power unit (HPU) 15 (shown in FIG. 1) powers the hydraulic motors 24 and 25. The HPU may be a closed loop system for example, or an open loop if desired. This HPU 15 allows for a fully variable speed to be obtained for each roll 26 and 27 thereby providing a variable friction ratio, which is the differential between roll speeds. The hydraulic drives 24 and 25 run much quieter than standard electromechanical drives currently found on conventional two roll processing mills. Further, conventional two roll processing mills have none or a fixed friction ratio. The apparatus of the present invention is capable of obtaining a variable friction ratio of greater than 3:1, or more preferably greater than 10:1, with the drive systems even providing a selectable friction ratio of up to 60:1. This allows the apparatus of the present invention to quickly and efficiently to reduce the particle size of hard, vulcanized rubber found in scrap tires, for example. This in conjunction with other aspects of the invention provide a system which allows various materials, including rubber and other elastomeric materials, to be effectively processed at ambient temperatures.

In one embodiment, the hydraulic system may incorporate a regenerative hydraulic circuit. The regenerative circuit may be utilized to assist in driving one of the hydraulic drive motors at a faster speed, or to conserve energy. For any given pair of roller assemblies, two hydraulic motors are needed to drive one of the roller assemblies respectively. As it is desirable to provide a friction ratio or differential speed between the two roller assemblies, using the fluid output from one of the motors will help increase robustness of the system in driving the roller assemblies at the desired ratio of speeds. In this way, the hydraulic fluid output from one of the motors may be directly communicated to the input of the other motor. In other words, hydraulic flow into the other motor may come from both the output of the first motor and the reservoir via the hydraulic pump or hydrostatic unit. However, any manner of connecting a hydraulic circuit to increase fluid flow to the motors in a regenerative circuit may be chosen with sound engineering judgment.

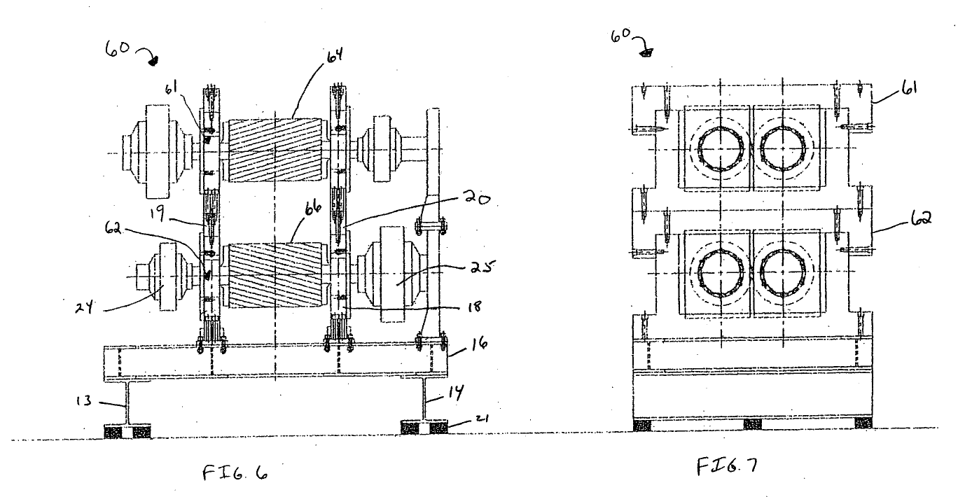

The pair of substantially cylindrical, material processing roller assemblies 26 and 27 mounted within support frames 12 are shown in more detail in FIGS. 3-5. The rolls 26 and 27 may be constructed to facilitate operation of apparatus 10, by allowing rolls 26 and 27 to be easily removed and replaced, or reconfigured. The rolls 26 and 27 may be constructed of a pair of end plate members 30, as shown in FIG. 3. The end plate members 30 comprise a shaft 32, which on one side is selectively coupled to and driven by a drive motor for imparting rotational motion to member 30 and the roll 26 or 27 with which it is used. The shaft 32 is also supported for rotational motion in bearings as previously described. The members 30 also have mounting plates 34, which may include a number of mounting holes 36 formed therein. The shafts 32 may include a channel 38 formed therein, to allow a cooling fluid to be circulated through roll 26 or 27. The members 30 are selectively coupled to a main body portion 40, which also is provided with a working surface 42 formed on its outer surface. The working surface 42 may have corrugations or processing teeth 44 formed thereon. The roll body 40 may be hollow to allow a cooling fluid to be circulated therethrough to control temperature of the working surface 42. The edges of roll body 40 may be provided with journalled mounting holes 46 for mounting of end plate assemblies 30, using bolts or other suitable fasteners. Based upon the construction of assemblies 30, it should be recognized that the main body 40 may be easily removed by simply unfastening it from end plates 30. In this manner, the roll body 40 may be removed and replaced quickly, for maintenance or the like.

Each of the roll bodies 40 of the present invention may be made of a high carbon steel alloy that does not crack and allows for a roll hardness of 60 Rc. Currently, only one-piece conventional chilled cast iron rolls are used for milling systems. These cast iron rolls have a propensity to crack, and can only achieve 50-55 Rc. Further, rolls according to the invention may be remanufactured multiple times by regrinding the teeth after wear. As the rolls are formed of steel, the rolls may be re-hardened after any such remachining to provide the desired hardness. Prior cast iron rolls cannot be re-hardened, and lose the benefits of hardening upon wear or attempts to remanufacture the rolls.

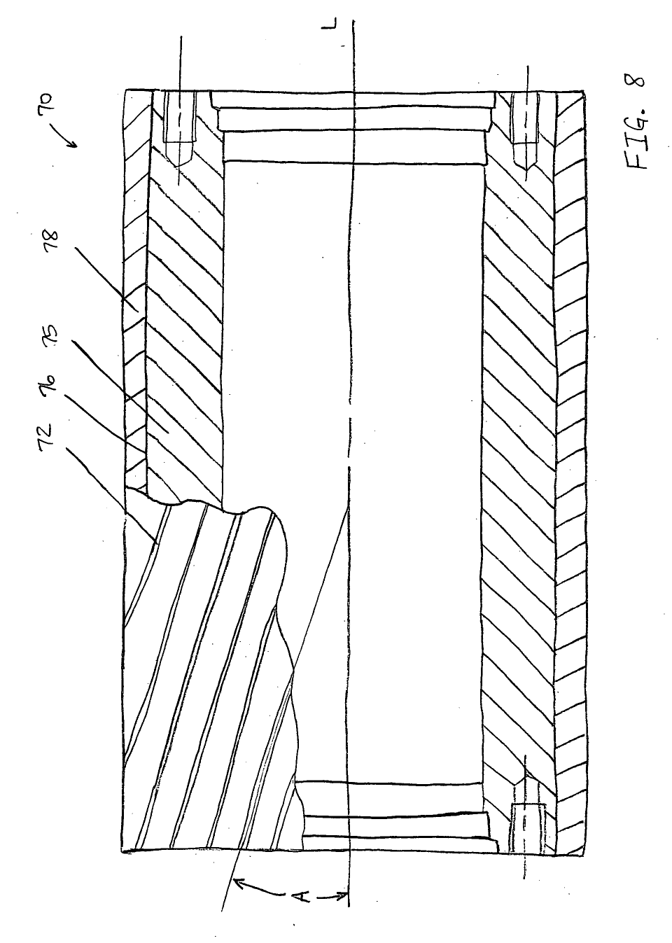

In another embodiment of the present invention, as seen in FIGS. 6 and 7, a system generally indicated at 60 includes first and second support frames 61 and 62, such as similar to that previously described. In this embodiment, the frames 61 and 62 are stackable, such that the pairs of material processing rolling assemblies 64 and 66 of each are stacked relative to each other. Although two machines are shown in the stacked configuration, additional machines may also be stacked if desired. Support frames 61 and 62 are configured to allow stacking and connection of frames 61 and 62 to one another.

In use, a feedstock, such as an elastomeric material is supplied for processing. For example, the feedstock may be a tire shred ranging in size from about 0.5 inches to about 10 inches. The material is fed into the material processing apparatus 10 or 60 of the present invention, and passes through material processing roller assemblies, being counter-rotating corrugated rolls. The rolls are differentially driven to provide the desired amount of shear along with the compression provided at the roll nip. Material is passed through the roll nip, formed as a gap between the two roll assemblies, such as in a range from about 0.001 inches to about 0.015 inches. As the material passes between roller assemblies, the individual corrugations found on each of the rolls along with the roll nip and friction ratio tend to tear and grind the material to reduce its size. Roller assemblies may be driven to have a variable and high friction ratio that produces thermal energy tending to facilitate the process. With a rubber material, the method results in the formation of crumb rubber of a desired size, formed after one or more passes through the machine. In this regard, it should be understood that the process and systems may include providing selective screening of material after processing, and recirculation of oversized material for further processing, in accordance with the invention. Further, for recycling tires, a magnet may be provided to remove metal from the processed material. Additional crumb rubber is produced as the rubber begins to heat around a temperature of about 150° F.

In the embodiment of FIGS. 6 and 7, after the material passes through the top roller assemblies, the material drops directly into the counter-rotating roller assemblies of the machine below. This second pair of roller assemblies further reduces the shredded crumb rubber to smaller sizes that include a range from about 2000 microns to about 180 microns. A conveyor below the material processing system may then be used to remove the material for use or further processing, such as for screening and/or magnetic separation of any steel particles found in the material.

With reference to FIG. 8, another embodiment of the present invention will now be discussed. FIG. 8 shows a material processing rolling assembly depicted generally at 70. Similar to the roller assemblies described above, the two roller assemblies of this embodiment are also rotatably connected with respect to the frame. Only one roller assembly is shown in the Figure. However, it is understood that at least two roller assemblies are needed to process the material into smaller pieces as described above. The roller assembly 70 may again include corrugations 72 fashioned in an outer surface of the roller assembly, as do the rolls 26, 27. The roller assembly 70 may include an inner or middle roll body 75 and an outer processing sleeve 78. The middle roll body 75 may be constructed from steel having a generally hollow center for allowing cooling fluids, or other heat dissipating substances, to flow therethrough thus dissipating heat generated by processing the rubber or other materials. Cooling fluid may be channeled through the end plates as discussed previously. The middle roll body 75 may have an exterior surface 76, which may be dimensioned to receive the outer corrugated sleeve 78, as shown in FIG. 8. The sleeve 78 may be slid in place over the middle roll body 75 or press fit or otherwise operatively attached to roll body 75. Afterwards, the sleeve 78 may be held in place by fasteners, not shown, as extended through the end plates. In fact, any means of fitting the sleeve 78 onto the roll body 75 and securing it from rotation with respect to the middle roll body 75 may be chosen as is appropriate for use with the current embodiment of the present invention. The processing sleeve 78 may be provided with teeth or corrugations to facilitate various processing methods. In this manner, as the sleeve 78 or corrugations 72 wear from use, only the sleeve 78 needs to be replaced saving time and money. As the roller assembly 70 is modular with selectively removable end plates, the entire roller assembly is easily repaired or different processing methods may easily be employed by modifying or changing sleeve 78.

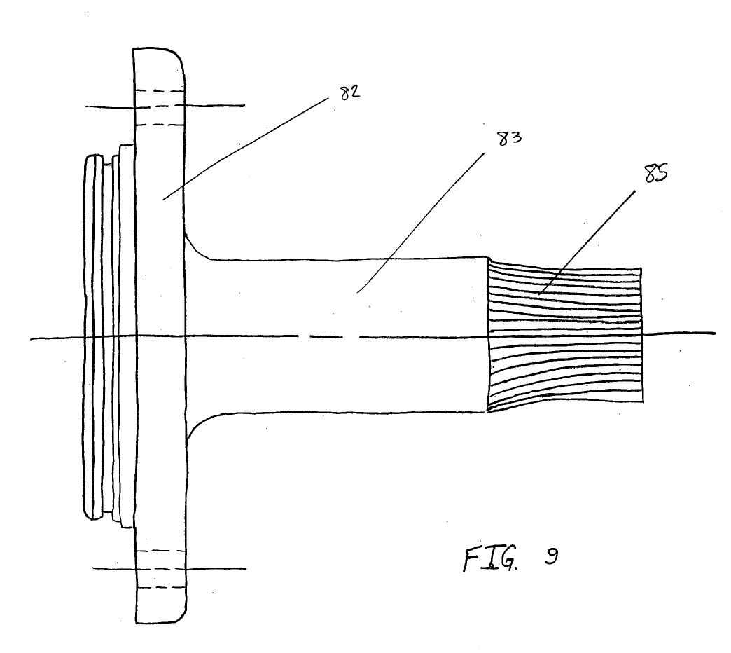

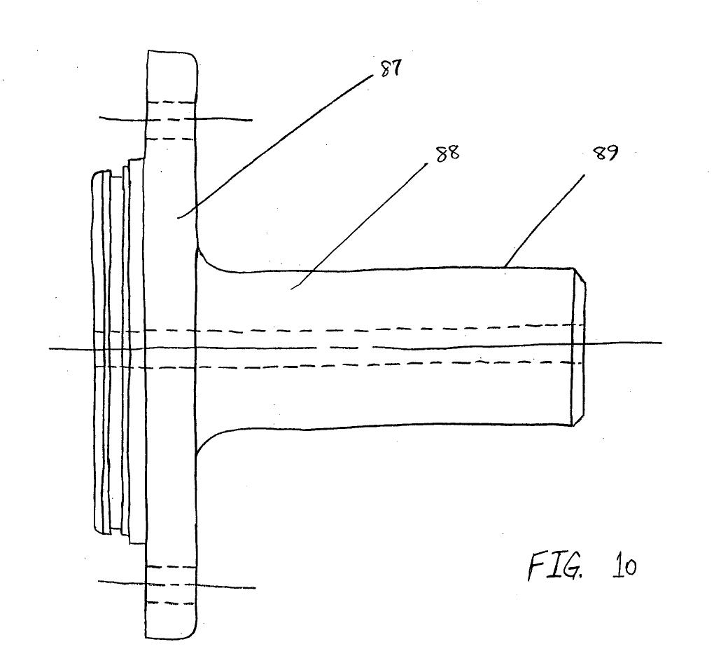

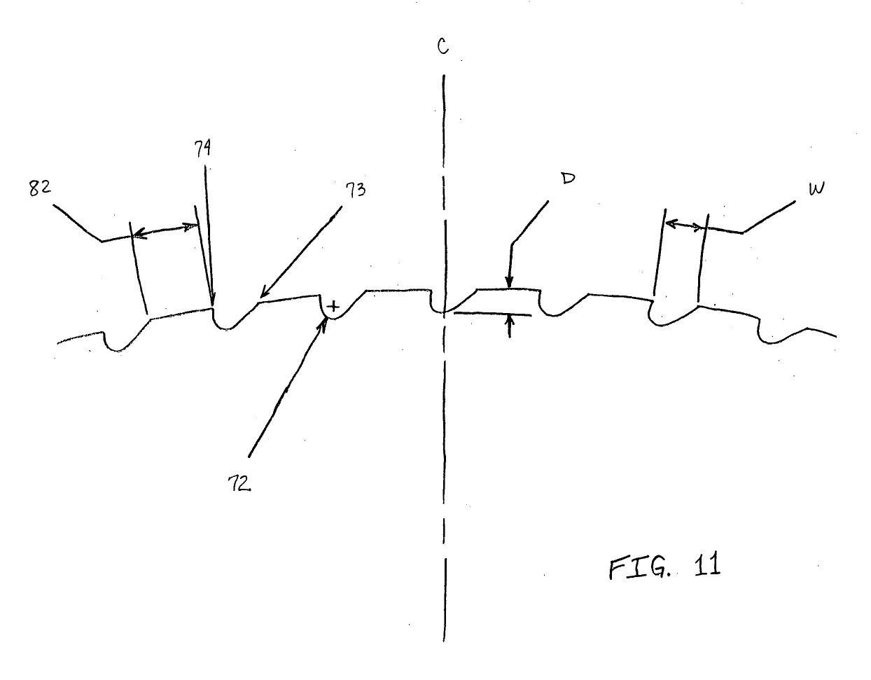

With reference now to FIGS. 9 and 10, end plates 82 and 87 for mounting and driving rolls are described in the various embodiments are depicted respectively. End plate 82 may be a drive plate 82 having a shaft portion 83 extending perpendicularly out from the plate 82. The drive plate 82 may be constructed as a unitary piece, as in the case of a casting. The drive plate 82 may also be fabricated using various processes such as welding and machining. However, any means of constructing the end plates 82, 87 may be chosen with sound engineering judgment. The shaft portion 83 may have a splined end 85 for connecting to a drive motor. In this way, the drive motor, which may be a hydraulic drive motor, can be directly connected to the drive plate 82 via the splined end 85. A matching splined surface can be included within the drive motor for receiving the splined end 85 of the drive plate 82. This eliminates the need for a separate gear reducer and/or coupling thereby providing increased torque and a more robust system. End plate 87 may be a non-driven end plate 87 attached to the distal end of the roller assembly 70. In a similar manner, shaft portion 88 extends from the end plate 87. The shaft portion 88 may include a journalled end surface 89. This allows the non-driven end plate 87 to be inserted into a bearing, which may be a spherical bearing, for rotation of the roller assembly 70 with respect to the frame. It is noted that fasteners may be utilized to secure the end plates 82, 87 to be roller assembly 70 as shown by the threaded bolt holes fashioned in the roller assembly 70, depicted in FIG. 8. However, any suitable means of assembling the roller assembly 70 and end plates 82, 87 and rotatably securing the roller assembly 70 and end plates 82, 87 to the frame may be chosen. In this manner, the end plates 82, 87 and the roller assembly rotate as a single item and can be removed and repaired as such.

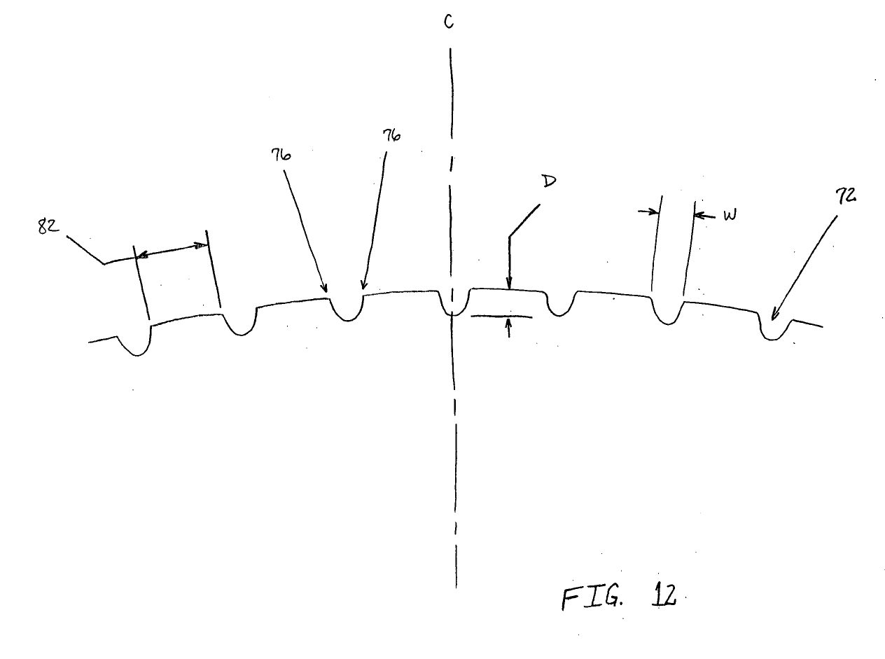

With reference now to FIGS. 11-13, teeth or corrugations 72 are shown fashioned in the surface of the roller assembly 70 or sleeve 78. The corrugations 72 may comprise a plurality of corrugations spaced equally apart in a generally parallel manner. While the foregoing description relates to corrugations that are generally parallel, it is contemplated in an alternate embodiment that any manner of spacing or skewing the plurality of corrugations may be chosen as is appropriate for use with various processing applications within the subject invention. The corrugations 72 may have a characteristic depth D. The range of depths D of the corrugations 72 may be between approximately 0.050 inches and 0.250 inches. However, the depths D of the corrugations 72 may depend upon the cross sectional configuration of the corrugations 72. FIGS. 11 and 12 show two different cross sectional configurations of corrugations 72: the saw-tooth configuration and the V-tooth configuration respectively. In FIG. 11, the saw-tooth shape may be characterized by a first side-formed as an undercut surface 73 from the roll surface. Surface 73 may be undercut between 0-10° from the roll surface. This then leads to a rounded bottom and a further leg 74 extending at approximately 30° to the roll surface. The saw-tooth design provides an aggressive cutting of the material being processed, with lands between the teeth providing shear and compression of the material. The cutting, tearing or shredding provided by the saw-tooth configuration, along with crushing provided by the land widths provide aggressive size reduction of the material. Thereafter, finer processing may be provided by further roll pairs having V-tooth and/or U-tooth configurations.

FIG. 12 shows a more symmetrical configuration; that of the V-tooth. In this configuration, the cross section of the corrugation 72 may include a round bottom having legs 76 that have substantially the same angle with respect to a centerline C of the cross section of the roller assembly 70 or sleeve 78. The outward sloping of legs 76 facilitate release of any particulate material from the corrugation. Each of the respective corrugations of the cross section configurations has a width W, which depends upon the angle at which the legs 73, 74 and 76 are constructed. Accordingly, a land width 82 remains between the corrugations 72. This land width 82 may have significant impact on the processing of the material. Thus, the tooth configuration along with the land width 82 may have a significant effect on processing characteristics relative to various materials or applications, and variations of these parameters over a wide range are contemplated in the invention. As examples of preferred forms, the land width may range from approximately 0.250 inches to 0.60 inches depending on the configuration of the cross section of the corrugations 72 as will be discussed further below. It is also noted at this time that all of the corrugations 72 on a single roller assembly 70 or sleeve 78 may be the same or of different configurations. Further, the corrugations may all have the same direction or may be in opposing directions.

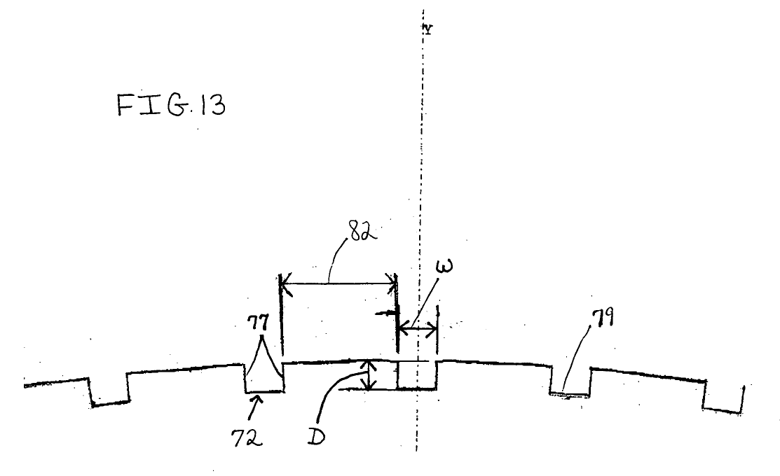

In FIG. 13, a U-tooth configuration is shown. In this configuration, the cross section of the corrugation 72 may include a U-shape having first and second legs 77 and a bottom 79 with corners therebetween. This configuration may be particularly useful in conjunction with finer processing steps, and may be used with a corresponding roll having V-tooth corrugations. Each of the corrugations 72 has a width W and depth D, which can be selectively varied similar to the other corrugation configurations as described previously. A land width 82 is again provided between teeth 72, which also can be varied as previously described.

With continued reference to FIGS. 11-13, the saw tooth cross section may comprise the more aggressive processing configuration with roller assembly 70. In other words, the roller assemblies 70 having the sawtooth cross section of corrugations 72 may be capable of reducing an associated material more effectively than that of the V-tooth or U-tooth cross section. Conversely, the V-tooth and U-tooth cross sections may be capable of reducing the associated material into smaller particles more effectively than the saw tooth cross section for various materials or situations. As such, a combination of corrugations 72 and roller assemblies 70 may be desired when processing material. Specifically, when it is desired to produce crumb rubber, the more aggressive roller assemblies 70 may be utilized first for larger pieces of rubber, and the other tooth configurations used to produce a smaller particle end product. In an example embodiment, the roller assemblies 70, with the saw tooth cross section of corrugation 72 may have a depth D in the range of substantially 0.125 inches and a land width 82 in the range of substantially 0.332 inches. This may constitute an aggressive configuration of roller assembly 70. Additionally, the roller assemblies 70, with the V-tooth or U-tooth cross section of corrugation 72 may have a depth D in the range of substantially 0.100 inches, a width W in the range of substantially 0.125 inches, and a land width 82 in the range of substantially 0.373 inches. At another level of refinement, the V-tooth cross section may have a land width of substantially 0.478 inches and a depth of approximately 0.080 inches. A series of roll pairs may successively reduce the depth and increase the land width for finer processing.

As mentioned above, the corrugations 72 may be spaced apart in a generally parallel manner. In one embodiment, the corrugations 72 may form an angle A with a longitudinal axis L of roller assembly 70. The angle A may fall in the range of 8 to 12 degrees. However, a preferred angle A would be substantially 10 degrees. It is noted that the angle A follows to the right of the longitudinal axis L, known as a right-hand helix. In other words, the corrugations move from left to right with respect to the longitudinal axis L. Generally, the roller assemblies 70 rotate in a counter clockwise manner both having the same right hand helix configuration, wherein the right hand helixes create a cross pattern at the roll nip to process the material.

The process of shredding the material may start with the more aggressive corrugations, for example the saw tooth configuration. In this manner, larger pieces of material can be reduced quickly for further processing into smaller pieces or crumb material by the V-tooth configurations. An intermediate processing step may comprise combining one saw tooth corrugations fashioned on a roller assembly, with a V-tooth corrugation on the other assembly. However, it is noted that any combination of cross section, land width and/or depth D may be chosen as is appropriate for use according to the subject invention. As in the case of the stacked embodiment described above, the upper pair of roller assemblies 70 may constitute the more aggressive processing configurations of roller assemblies. For example, the saw tooth cross section on the roller assemblies may be on the top. As the rubber passes through these assemblies, it falls downward onto the next pair of roller assemblies 70, which may include one assembly having corrugations with a saw tooth cross section and the other assembly with a V-tooth cross section or one roll with a V-tooth and the other with a U-tooth configuration. In another embodiment of a stacked apparatus 60, an upper pair of assemblies 70 may have one saw tooth cross section and one V-tooth cross section, while the lower pair may both have V-tooth or U-tooth cross sections or a combination of these for processing the particular material even smaller. It is to be construed that a wide variety of configurations of pairs of roller assemblies 70 may be chosen as is appropriate for processing the rubber or other materials into smaller and smaller particles.

The foregoing description of embodiments of the present invention has been provided for the purposes of illustration and description. It is not intended to be exhaustive or to limit the invention to the precise forms disclosed. Obviously, many modification and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A material processing apparatus, comprising:
a modular frame including a base and a pair of laterally opposed sides selectively attached to the base;
first and second material processing rolling assemblies operatively and rotatably connected with the sides of the frame; and
at least first and second drive motors connected to rotatably drive the first and second material processing rolling assemblies.

2. The material processing apparatus of claim 1, wherein the sides of the frame include a first side support members and at least one rolling assembly support member having a bearing system therein to receive and rotatably support at least one of the rolling assemblies, and a cap member to selectively secure the at least one rolling assembly support member to the frame.

3. The material processing apparatus of claim 2, wherein each of the rolling assemblies is supported on a rolling assembly support member having a bearing system associated therewith.

4. The material processing apparatus of claim 1, wherein the base comprises first and second legs to be supported on a surface, and a support platform positioned on the legs to form a stable surface to which the sides are attached.

5. The material processing apparatus of claim 1, wherein first and second legs have anti-vibrational mounts associated therewith.

6. The material processing apparatus of claim 1, the first and second material processing rolling assemblies can be selectively driven at different speeds.

7. The material processing apparatus of claim 1, wherein the drive motors are hydraulically driven radial piston motors.

8. The material processing apparatus of claim 7, wherein the hydraulically driven radial piston motors are variable speed motors which allow various rotational speeds to be imparted to the rolling assemblies.

9. The material processing apparatus of claim 1, wherein the drive motors are hydraulic motors and the apparatus further comprising a closed loop hydrostatic power supply operatively connected to the first and second hydraulic motors.

10. The material processing apparatus of claim 9, wherein a hydraulic fluid output of the first hydraulic drive motor is operatively connected to an input of the second hydraulic drive motor creating a regenerative hydraulic circuit for assisting in driving the first and second hydraulic drive motors at different speeds.

11. The material processing apparatus of claim 1, wherein the first material processing rolling assembly is driven in a counter-rotating relationship with respect to the second material processing rolling assembly, and,
wherein the material processing rolling assemblies can be driven such that a variable friction ratio of greater than 10:1 can be obtained between the rolls.

12. The material processing apparatus of claim 11,
wherein the material processing rolling assemblies can be driven such that a variable friction ratio of up to 60:1 can be obtained between the rolls.

13. The material processing apparatus of claim 1, wherein the first and second material processing rolling assemblies are formed to include an outer material processing surface formed on a separate sleeve member which is selectively mounted on a roll body of the rolling assembly.

14. The material processing apparatus of claim 1, wherein the rolling assemblies have a plurality of corrugations formed substantially parallel and having a land width therebetween, wherein the land width is in the range of 0.250 inches to 0.60 inches.

15. The material processing apparatus of claim 1, wherein the material processing rolling assemblies further comprise first and second end plates operatively connected to hold the middle roll body for rotation during the processing of associated material.

16. The material processing apparatus of claim 15, wherein the first end plate is a drive plate having a shaft portion configured to directly connect to a drive motor, and the second end plate is a non-driven end plate having a shaft portion operatively rotatably connected with respect to the frame.

17. The material processing apparatus of claim 1, wherein the roll body is hollow and adapted to receive a cooling fluid for use in dissipating heat generated during material processing.

18. A material processing apparatus, comprising:
a frame;
first and second material processing rolling assemblies operatively and rotatably connected with respect to the frame to form a processing zone therebetween;
a drive motor operatively connected to each of the first and second material processing rolling assemblies; and,
wherein the drive motor provides an adjustable driving speed to the associated rolling assembly which enables a rotational speed ratio of greater than 10:1 to be achieved between the rolling assemblies.

19. The material processing apparatus of claim 18, wherein the drive motors are hydraulic drive motors coupled to a closed loop hydrostatic power supply.

20. A material processing apparatus, comprising a first modular frame including a base and a first pair of laterally opposed side supports selectively attached to the base, with a first pair of material processing rolling assemblies operatively and rotatably connected with the first pair of sides of the frame, and having a first drive system connected to rotatably drive the first pair of material processing rolling assemblies, and further comprising:
a second frame including a second pair of laterally opposing side supports for supporting a second pair of material processing rolling assemblies operatively rotatably connected with respect to the second frame, and having a second drive system connected to rotatably drive the second pair of material processing rolling assemblies, and,
wherein the second frame is fixedly connected to the first frame in a stacked relationship such that associated material processed by the second pair of material processing rolling assemblies are automatically fed into the first pair of material processing rolling assemblies for further processing.

21. A method of reducing materials to smaller particles comprising the steps of:
providing a material processing apparatus comprising first and second material processing rolling assemblies operatively and rotatably connected with respect to a frame to form a processing zone therebetween,
driving the first and second material processing rolling assemblies to provide a differential rotational speed ratio of greater than 10:1 to be achieved between the rolling assemblies,
selectively introducing a material to be processed to the processing zone between the rolls to reduce the size of the material.

22. The method according to claim 21, further comprising the steps of screening material processed through the first and second material processing rolling assemblies to remove materials that have been reduced to a predetermined particle size, and recirculating the oversized material to the first and second material processing rolling assemblies.
